(19) United States
(12) Patent Application Publication
(10) Pub. No.: US 2014/0079132 A1
(43) Pub. Date: Mar. 20, 2014

(54) METHOD AND DEVICE FOR FILTERING CODED IMAGE PARTITIONS

(71) Applicant: Peter Amon, Munich (DE)

(72) Inventor: Peter Amon, Munich (DE)

(73) Assignee: SIEMENS AKTIENGESELLSCHAFT, München (DE)

(21) Appl. No.: 14/116,052

(22) PCT Filed: Apr. 23, 2012
(86) PCT No.: PCT/EP2012/057344

§ 371 Date: Nov. 6, 2013

(30) Foreign Application Priority Data
May 6, 2011 (EP) 11165099.0

(51) Int. Cl. H04N 7/26

(52) U.S. Cl. CPC H04N 19/00896
USPC 375/240.16; 375/240.29

(57) ABSTRACT

In a sequence of digitized images having a plurality of pixels, a signal is coded for each of the images that is dependent on the image content of the images. The uncoded signal is reconstructed and reconstructed images are derived therefrom in the course of the coding process. The reconstructed images undergo filtering in which a particular reconstructed image is divided into partitions with at least one filter parameter defined for each partition. At least some of the partitions are respectively described using one or more parameters of a function that describes the curve of pixels within a predetermined image region, the pixel curve dividing the predetermined image region into at least two partitions.

### CROSS REFERENCE TO RELATED APPLICATIONS

This application is the U.S. national stage of International Application No. PCT/EP2012/057344, filed Apr. 23, 2012 and claims the benefit thereof. The International Application claims the benefit of European Application No. 11165099 filed on May 6, 2011, both applications are incorporated by reference herein in their entirety.

### BACKGROUND

Described below is a method for coding a series of digitized images, together with a corresponding decoding method. Also described is a coding device and a decoding device for carrying out respectively the coding and decoding method.

The method can be applied in the field of video coding. In this, appropriate compression methods are used to compress the contents of temporally consecutive digital images having a plurality of pixels, in doing which similarities between temporally neighboring images are generally taken into consideration in a suitable way in order to reduce the size of the compressed image stream.

For the purpose of improving the image quality of a coded image stream after it has been coded, various filtering methods are known from the related art. In these, images in the image stream which have already been coded are reconstructed again, and appropriate filtering is applied to them, analogous to that used in the decoding. In present-day coding methods, use is made in particular of deblocking filters and Wiener filters. In the case of deblocking filtering, artifacts produced by the compression at the boundaries of coded image blocks are reduced. In the case of Wiener filtering, a comparison is made between the reconstructed images and the original images, and corresponding filter coefficients are determined in such a way that the mean square of the errors between the reconstructed and original images is minimized.

Modern coding methods incorporate a prediction loop in which the temporally next image is predicted, by appropriate movement estimation, from one or more temporally preceding reconstructed images. In doing so, the prediction error between the image which is to be coded and the predicted image is coded as a signal. Frequently, the filters mentioned above are used within the prediction loop. In this case, the filters are also referred to as loop filters.

From the related art, the use of so-called adaptive loop filtering is known, whereby only certain image regions of the image are subject to filtering. In T. Chujoh, N. Wada and G. Yasuda, “Quadtree-based Adaptive Loop Filter”, ITU-T SG 16, document C181, Geneva, January 2009, an image block is subdivided for this purpose into ever smaller image blocks, by initially splitting up the original image block into four smaller equal-sized image blocks and then hierarchically splitting up the smaller image blocks repeatedly in the same way into ever smaller image blocks. In doing this, a signal is given for each image block as to whether or not filtering of the image block should take place. The filtering described in T. Chujoh et al. has the disadvantage that it is necessary to signal for each individual block whether or not filtering is used, so that when there is a large number of subdivided blocks it is necessary to communicate much additional data in the coded image stream.

### SUMMARY

Described below are methods of respectively coding or decoding an image stream, which achieves simple and flexibly adaptable filtering of the images in the image stream.

The coding method codes a series of digitized images having a plurality of pixels, whereby a signal which depends on their image content is coded for each of the images concerned. As part of the coding, a reconstruction of the uncoded signal is carried out, and from this are derived reconstructed images which are preferably used as part of a temporal prediction in the coding of subsequent images in the series. The reconstructed images are subject to filtering, by which each of the reconstructed images concerned is split up into partitions and for each partition one or more filter parameters are defined.

The coding method is distinguished by the fact that at least some of the partitions are each specified by one or more parameters of a function which specifies a path of pixels within a predefined image region, where the path of pixels splits up the predefined image region into at least two partitions. The predefined image region represents in particular the individual image subregions which, as part of the coding, are processed separately in the form, as applicable, of so-called coding units or on the other hand as image subregions of these coding units.

The coding method is based on the idea that it is possible to specify, by an appropriately parameterized function, various pixel paths within an image region, and it is possible thereby to create partitions of various shapes, to each of which suitable filter parameters can be assigned. As a result, a very flexible coding of the images in an image stream is achieved. The coding method can be utilized for any required coding method. In particular, the method can be used in the HEVC (High Efficiency Video Coding) video coding standard, which is still under development.

In a variant of the coding method, filtering is utilized in a predictive video coding method. In this case a prediction error, between the image currently to be coded and one or more reconstructed and predicted images, is coded as the signal, with the prediction error being determined within a prediction loop from one or more earlier reconstructed images which are subject to movement compensation making use of movement vectors determined through movement estimation. Here and in what follows, the expression reconstruction of an uncoded image refers in particular to the regeneration by approximation of the original image from the coded signal. An exact reconstruction is not generally possible because of image losses evoked by the coding. Here, the reconstructed image(s) after the movement compensation is/are used within the prediction loop for the reconstruction of one or more subsequent images. In doing this, the filtering will preferably be used within the prediction loop for loop filtering before or after the movement compensation. That is to say, within the prediction loop the reconstructed images used for the purpose of determining the prediction error are subject to the filtering in addition to the movement compensation. This notwithstanding, there is also the possibility that the reconstructed images used for the purpose of determining the prediction error are unfiltered, and the filtering of the reconstructed images takes place outside the prediction loop.

In a particularly preferred variant, the coding makes use of a method in which the coded image is produced by a transformation and a quantization, and for the reconstruction of the uncoded signal a corresponding inverse quantization and inverse transformation are applied to the coded signal, where the coded signal, after the quantization and transformation, preferably undergoes a further entropy coding. The entropy coding increases yet further the coding efficiency, without any further loss of information from the image. Then, as part of the decoding, a corresponding entropy decoding is initially applied, before being followed by the application of inverse quantization and inverse transformation to the coded signal.

As part of the filtering, it is possible to use any arbitrary filters used in the related art. In particular, use can be made of the Wiener filter, already mentioned above, or alternatively or additionally even a deblocking filter.

In a further particularly preferred embodiment, each of the predefined image regions, which are split up into at least two partitions by the path of pixels, are rectangular image regions and preferably square image regions in the form of image blocks. As already mentioned above, the image regions are here, in particular, appropriate coding units or sub-regions of these coding units, as appropriate.

The function which specifies the path of pixels within the predefined image region can be selected as required, depending on the application situation. In one particularly preferred embodiment, a straight line is used. Preferably, the straight line then runs obliquely in an appropriate rectangular image region, i.e. at the points where the straight line intersects an applicable edge of the image region the straight line is not perpendicular to the border of the image region. Alternatively or additionally, the appropriate path of pixels in the predefined image region can also be specified by other functions, such as for example by a polynomial and/or a spline (in particular a B-spline) which represents a piecewise compilation of polynomials.

The appropriate filter parameters, which are defined for the individual partitions in the image, can be in any desired form. In one variant of the coding method, the filter parameters specify solely whether or not filtering is effected in the partition concerned. Equally, it is also possible to use the filter parameters to specify which type of filter is used in the predetermined image region. In particular, it is possible to define specific filters for the different partitions, such as for example the Wiener filter or deblocking filter described above, or other specific filter types or special filter characteristics.

In a further embodiment, the subdivision of partitions on the basis of parameters of a function is combined with hierarchical block subdivision. That is to say, the predefined image regions, which are split up into at least two partitions, are each produced by a hierarchical subdivision of the corresponding image into ever smaller image regions. Here, hierarchical splitting of an image means that an image region is subdivided on the basis of a rule into a predefined number of smaller image regions, which can in turn be subdivided in an analogous way on the basis of the same rule into further smaller image regions, and so on. An example of such a hierarchical image subdivision will be found in T. Chujoh et al. mentioned in the introduction, where an image block is subdivided in steps into four smaller image blocks of equal size.

In a further embodiment of the coding method, the filter parameter(s) for the partitions concerned and/or the parameter(s) of the function which specifies the path of pixels within the predefined image regions concerned is/are contained in the coded image sequence. Alternatively or in addition, there is also the possibility that the filter parameters or the parameters of the appropriate function, as applicable, can be deduced from one or more predefined coding parameters. For example, the nature of the function (linear, polynomial, spline etc.) can be implied by an appropriate profile, which specifies the coding.

In another embodiment of the coding method, in which a prediction is made with the aid of movement estimation, partitions, which are defined as part of the movement estimation and which in each case use movement vectors to show image regions which have moved, are used at least in part as partitions for the filtering. In particular, it is possible here to use the movement estimation described in publication [2] P. Chen, W. Chien, R. Panchal, M. Karczewicz, “Geometry motion partition” JCT-VC of ISO/IEC SG29 WG11 (MPEG) and ITU-T SG16 Q.6(VCEG), document JCTVC-B049, Geneva, Switzerland, July 2010, in which the partitions which have moved are defined by the splitting up of a block on the basis of the appropriate parameters of a straight line.

In addition to the coding method described above, described below is a method for the decoding of a series of digitized images which have been coded using the coding method so that for each of the images a coded signal is obtained which depends on their image content. As part of the coding, a reconstruction of the uncoded signal is carried out, and from this are derived reconstructed images which are, preferably, used in the decoding of subsequent images in the series. The reconstructed images are subject to a filtering which corresponds to the filtering used in the coding, by which during the filtering each of the reconstructed images is split up into partitions and for each partition one or more filter parameters are defined. Just as in the coding, at least some of the partitions are each specified by one or more parameters of a function which defines the path of pixels within a predefined image region, where the path of pixels splits up the image region into at least two partitions. The decoding method is preferably arranged in such a way that it is possible to decode a series of digitized images which was coded on the basis of one or more preferred variants of the coding method. i.e. the decoding method also covers the decoding of a series of digitized images which was coded using embodiments of the coding method.

In a method for coding and decoding a series of digitized images, the images in the series are coded using the coding method described above and the coded images in the series are decoded using the decoding method described above.

The device described below for coding a series of digitized images having a plurality of pixels, includes a coding facility for coding a signal which, for each of the images, depends on their image content, where the coding facility includes:

a reconstruction facility, with which a reconstruction of the uncoded signal is carried out as part of the coding, and from this are derived reconstructed images which are used, in particular, in the coding of subsequent images in the series;

a filtering facility which subjects the reconstructed images to filtering by which any particular reconstructed image is split up into partitions, and for each partition one or more filter parameters are defined, where at least some of the partitions are, in each case, specified by one or more parameters of a function which specifies the path of pixels within a predefined image region, where the path of pixels splits up the predefined image region into at least two partitions.

In a corresponding decoding device for decoding a series of digitized images which was coded using the coding method, the device uses a decoding facility to process a coded signal, which depends on the image content of each of the images concerned, where the decoding facility includes:

a reconstruction facility, with which a reconstruction of the uncoded signal is carried out as part of the decoding, and from this are derived reconstructed images which are used, in particular, in the decoding of subsequent images in the series;

a filtering facility which subjects the reconstructed images to filtering, which corresponds to the filtering used during the coding, by which in the filtering each of the reconstructed images is split up into partitions, and for each partition one or more filter parameters are defined, where at least some of the partitions are, in each case, specified by one or more parameters of a function which specifies the path of pixels within a predefined image region, where the path of pixels splits up the predefined image region into at least two partitions.

The method can be applied to a codec, for coding and decoding a series of digitized images, which includes a coding device and a decoding device.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram providing a schematic representation of coding and decoding based on an embodiment of the method;

FIG. 2 is a schematic representation of an image region which has been filtered on the basis of adaptive loop filtering in accordance with the related art;

FIG. 3 a diagram showing different variants of a partitioning of image regions, used as part of the filtering;

FIG. 4 is a schematic representation of an image region which has been partitioned on the basis of one embodiment of the filtering; and

FIG. 5 is a schematic diagram of a coding device and a decoding device for carrying out the method.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

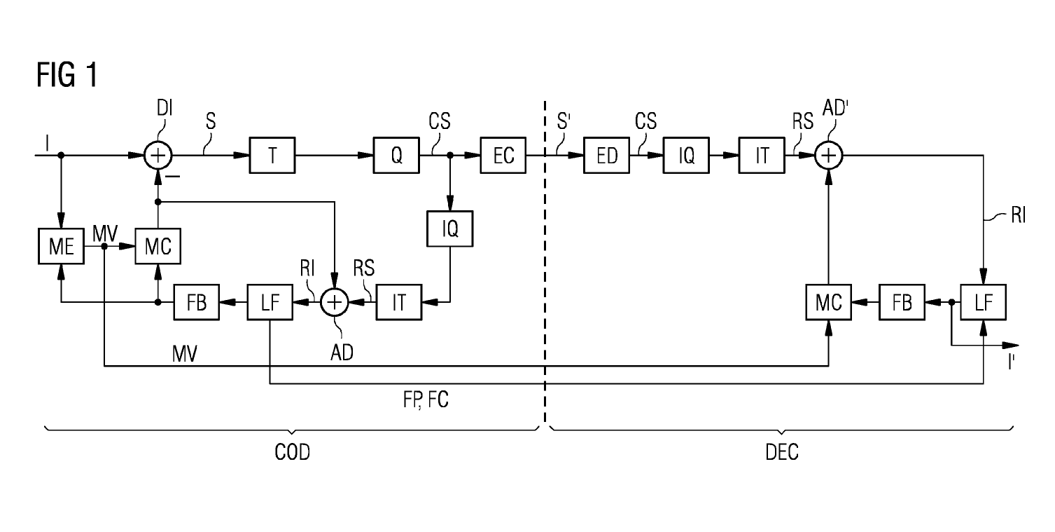

The embodiment of the method described below is based on the architecture shown in FIG. 1 for hybrid video coding, where the components shown are known per se from the related art. The difference between the method and the related art lies in the carrying out of filtering on the basis of the loop filter LF shown in FIG. 1, as described in yet more detail below.

The architecture in FIG. 1 shows coding COD for a stream of video images I from which is determined, with the help of the differentiator DI, a prediction error signal S which is subject to a transformation (in particular a DCT Transformation; DCT=Discrete Cosine Transformation), which is known per se, and then a quantization Q which is also known per se, by which a compressed prediction error signal CS is obtained. This signal undergoes lossless entropy coding EC. The signal S′ thereby obtained is then decoded using appropriate decoding DEC.

For the purpose of determining the prediction error signal S which is to be coded, appropriate video images for previous points in time are taken into consideration. In order to obtain these video images, error signals CS which have already been coded are subject to an inverse quantization IQ and inverse transformation IT. The reconstructed prediction error RS obtained from this is then combined with a movement-compensated signal using the adder AD. The reconstructed image BI which results from this is subject to filtering LF and is stored in a memory FB. As part of the movement compensation, movement estimation ME, which is known per se, is carried out using the original images I, from which are obtained movement vectors MV which specify the displacement of image blocks between the current image and the temporally preceding image. The movement vectors are used as part of the movement compensation MC to predict from the temporally preceding image a current image, which is then fed to the differentiator DI, which outputs the corresponding prediction error S. In addition, via the adder AD the movement-compensated image is combined with the corresponding reconstructed prediction error RS and stored in the memory FB, thus creating a prediction loop.

As already mentioned above, the reconstructed images RI are subject to filtering LF before they are stored in the memory FB. This filtering is effected within the prediction loop, and is therefore also referred to as loop filtering. In doing this, a Wiener filter is utilized, this being known per se from the related art. This filter minimizes the mean squared error between the current image I and the reconstructed image RI. As the result of the filtering one obtains filter coefficients FC, which are transmitted as page data to the decoder used for the decoding. As part of the method, the filtering is effected separately for different image regions, i.e. the appropriate parameters for the filtering can be defined differently for the various image regions. These filter parameters FP are also transmitted to the decoder used for decoding, as page data. In addition to this, the movement vectors MV determined by the movement estimation are communicated to the decoder.

As part of the decoding DEC, the coded signal S′ is initially subject to entropy decoding, from which the coded prediction error CS is obtained. This is subject to an inverse quantization IQ and inverse transformation IT. The reconstructed error signal RS which this produces is combined via the adder AD′ with a corresponding reconstructed image from the memory FB, which has undergone filtering LF and movement compensation MC. In this way, the decoded series of images I′ is obtained, and this can be accessed after the filtering LF. As part of the reconstruction of the images in the memory FB, account is taken of the movement vectors MV, together with the filter parameters FP and filter coefficients FC, which have been communicated. Analog filtering is effected as for the coding, on the basis of the filter parameters and filter coefficients, together with analog movement compensation using the movement vectors MV which have been communicated.

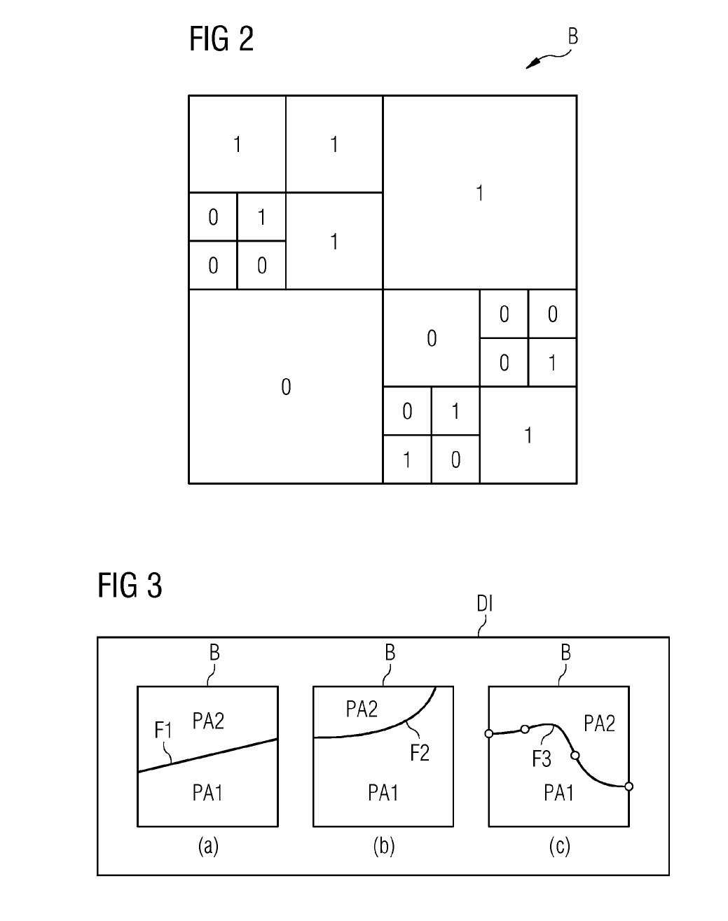

Before giving details of an embodiment of the loop filtering, a description is first given of an adaptive loop filter which is known per se, which can if necessary be combined with the filtering. A description of this adaptive loop filter can be found in T. Chujoh et al. With this filter, a coding unit in the form of an appropriate image block is divided up on the basis of a hierarchical block partitioning into smaller square image regions. This is represented in FIG. 2. The image block B illustrated is initially subdivided into four smaller image blocks, and after this the individual image blocks are again divided up if necessary into four smaller image blocks and these are if necessary divided again into smaller image blocks, and so on. In this way, a hierarchical subdivision into smaller image blocks is achieved, with a decision being made at each hierarchical level as to whether a division into smaller blocks should be effected or the block should be retained as one whole. Thus, in accordance with this subdivision four smaller sub-blocks are produced from the block which is currently being processed, these being half as large in the horizontal and vertical directions as the original block. For each node of this quad-tree (i.e. the sub-block for which no further subdivision is effected) the binary data is then stored, indicating whether or not filtering is to be effected for the sub-block. According to FIG. 1, filtering is to be provided for all the blocks which are labeled with 1, whereas the other blocks which are labeled with a zero will not be filtered.

The filtering also assumes a subdivision of an appropriate image block into smaller image regions, but the partitioning is not, or only optionally, carried out on the basis of hierarchical blocks which get ever smaller. Instead, use is made of parametric partitioning, this being indicated in FIG. 3 for different variants of the method.

FIG. 3 shows a diagram DI, which clarifies variants (a), (b) and (c) of a partitioning of an image block B. Here, a critical aspect is that, for the purpose of the partitioning, account is taken of one or more parameters of a function which specifies the path of pixels within the image block B which is to be appropriately partitioned. Variant (a) shows this partitioning based on a straight line which passes obliquely through the image block B concerned and divides it into the two partitions PA1 and PA2. In this case, the straight line is specified, in particular, by its slope and offset. For each partition it is specified, in a way analogous to the method shown in FIG. 2, whether or not filtering should be effected. Here, the position of the straight line can be arbitrary. In particular, it is possible that the straight line runs obliquely through the image block, this also being indicated in variant (a). Appropriate criteria, which determine the parameters of the straight lines and hence the splitting up into partitions, can be arbitrarily defined. The parameters of the straight lines will preferably be determined using suitable heuristics or recursive methods, as appropriate, in such a way that the squared error which results from the partitioning is minimized.

Instead of a partitioning based on a linear function, it is also possible to use other functions for the purpose of specifying the partitioning. Variant (b) in FIG. 3 represents this situation, with a partitioning based on a suitable polynomial. Further, the partitioning can be effected on the basis of a piecewise compilation of several polynomials, in the form of a spline, as indicated in variant (c). If necessary, other arbitrary functions can also be used for the purpose of the subdivision.

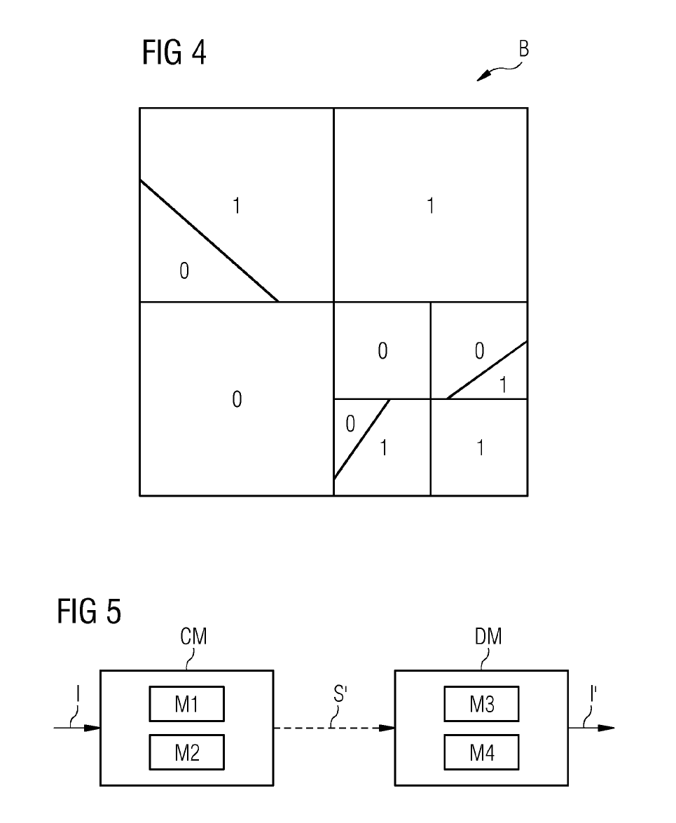

FIG. 4 shows a variant of the partitioning, which is combined with the hierarchical block subdivision shown in FIG. 2. In this case, the image block B is first subdivided in a suitable way into several sub-blocks. After this, for at least some of the sub-blocks in the quad-tree, which will not be further reduced in size as part of the hierarchical subdivision, a subdivision is undertaken on the basis of the partitioning, using a parametric specification of a pixel path in the form of a straight line. In FIG. 4, the partitioning is applied to the upper left-hand block together with two blocks lying diagonally opposite each other within the lower right-hand block. The digit 1 again indicates the performance of filtering in the corresponding image region, whereas the digit 0 signals that no filtering is applied in the image region.

The filtering indicated in FIG. 4 can if necessary also be achieved purely by quad-tree partitioning, in that subdivision into smaller blocks continues until this models an appropriate straight line as the pixel path. However, this requires a significantly larger number of partitions than is the case for subdivision by a linear function. Consequently, the use of filtering in accordance with the method leads to a significantly lower data rate for the compressed bit stream than pure quad-tree-based filtering.

In the embodiments of the method explained above, as part of the filtering a determination is made for the partitions concerned as to whether or not filtering is to be effected in the partitions concerned. If necessary, there is also the possibility of defining the filter parameters in a more differentiated way. For example, for different partitions it is possible to define different filters or different filter types, e.g. separable filters, non-separable filters, diamond filters and the like. In other variants there is the further possibility that the filtering is effected not as part of a loop filter within the prediction loop, but by an appropriate filter outside the prediction loop. Equally, the filter in FIG. 1 can be arranged at another position within the prediction loop, for example the filtering can be effected after the movement compensation MC.

The appropriate parameters, by which the function for partitioning a block is specified, can be signaled in various ways. For example, the type of the partitioning (linear, polynomial, spline and the like) together with appropriate parameters or coefficients for the type of partition used, such as the slope, points on the function which are known in advance, and the like, can be specified as parameters. The parameters can here be signaled explicitly in the compressed bitstream as filter parameters FP, as is also shown in FIG. 1. Equally, it is possible that the parameters are deduced from other coding parameters. For example, in the case of movement estimation use can be made of the method described in P. Chen et al., by which image blocks are partitioned using the parameters of a straight line just as in the method, where the partitions formed in this way are used for movement estimation. The corresponding parameters of the movement estimation can also be used, at least in part, for the purpose of filtering, so that appropriate filter parameters are also defined via the coding parameters for the movement estimation. Appropriate filter parameters can if necessary also be implied by the specification of the profile used for the purpose of coding. For example, it may be specified for a predefined profile that only a linear partitioning is permitted.

The method described above has a range of advantages. In particular, the filter which is used can be more precisely adjusted and controlled, which is of advantage particularly for complex scenes with several objects in the image. Furthermore, as already mentioned above, data rates can be cut down by comparison with a representation of the filter by hierarchical block subdivision. Over and above this, there is also the possibility of combining the filtering in a suitable way with hierarchical block subdivision, which leads to a very flexible partitioning schema for the filter.

FIG. 5 shows a schematic representation of a specific embodiment of a system with a coding device and a decoding device. The individual components of the system can here be realized in the form of hardware or software or a combination of hardware and software, as appropriate. The coding device includes a coding facility CM, which receives the stream of digitized images I which is to be coded. In this case, a coding of the prediction error takes place within the coding facility, as shown in FIG. 1, i.e. among other items appropriate units are provided for the transformation, quantization, inverse transformation, inverse quantization and entropy coding. In particular, the coding facility CM incorporates in this case a first facility MI in the form of a reconstruction facility, with which a reconstruction of the uncoded prediction error RS is carried out as part of the coding, and on the basis of this reconstructed images RI are derived. Over and above this, a second facility M2 is provided in the form of a filtering facility, with which the reconstructed images RI are subject to filtering, during which the partitioning of the images into sub-regions is effected.

The coded signal S′, which is obtained in the form of the coded prediction error as part of the coding, is transmitted to an appropriate decoding unit with a decoding facility DM which by analogy with FIG. 1 contains, among other items, appropriate components for entropy decoding, inverse quantization, inverse transformation and movement estimation. In particular, a third facility M3 is provided here, in the form of a reconstruction facility, which carries out a reconstruction of the uncoded signal RS during the decoding, and from this are derived the reconstructed images RI. Further, a fourth facility M4 is provided, in the form of a filter facility M4, with which the reconstructed images are subject to a filtering which corresponds to the filtering used during the coding, and subdivides the image blocks into suitable partitions. After the decoding has been concluded, the correspondingly decoded image stream, having a plurality of decoded images I′, is output.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-20. (canceled)

21. A method for coding a series of digitized images having a plurality of pixels, by which a coded signal which depends on image content is produced for each of the images concerned, comprising:
reconstructing an uncoded signal;
deriving reconstructed images from the uncoded signal after said reconstructing;
filtering the reconstructed images by dividing each reconstructed image into partitions; and
defining at least one filter parameter for each partition with at least some of the partitions each described by at least one parameter of a function specifying a path of pixels within a predefined image region, the path of pixels dividing the predefined image region into at least two partitions.

22. The method as claimed in claim 21, wherein a prediction error, between an image currently to be coded and at least one reconstructed and predicted image, is produced as the coded signal, with the prediction error being determined, by a prediction loop, from at least one earlier reconstructed image subject to movement compensation, making use of movement vectors determined through movement estimation, the reconstructed image being used, after the movement compensation within the prediction loop, in reconstructing at least one subsequent image.

23. The method as claimed in claim 22, wherein within the prediction loop the reconstructed images used in determining the prediction error are subject to filtering in addition to the movement compensation.

24. The method as claimed in claim 23, wherein the reconstructed images used in determining the prediction error are unfiltered, and the filtering of the reconstructed images takes place outside the prediction loop.

25. The method as claimed in claim 24,
further comprising
producing the coded signal by a transformation and a quantization; and
after the quantization and transformation, subjecting the coded signal to entropy coding, and
wherein said reconstructing of the uncoded signal utilizes inverse quantization and inverse transformation of the coded signal corresponding to the quantization and transformation used in said producing of the coded signal.

26. The method as claimed in claim 25, wherein said filtering of the reconstructed images is based on at least one of a Wiener filter and a deblocking filter.

27. The method as claimed in claim 26, wherein the predefined image region is a square image region formed of image blocks.

28. The method as claimed in claim 27, wherein the path of the pixels within the predefined image region is a straight line.

29. The method as claimed in claim 28, wherein the straight line runs obliquely through the square image region.

30. The method as claimed in claim 29, wherein the function which defines the path of the pixels within the predefined image region is at least one of a polynomial and a spline.

31. The method as claimed in claim 30, wherein the at least one filter parameter specifies at least one of whether filtering is effected in the partition and which type of filter is used in the partition.

32. The method as claimed in claim 31, wherein the predefined image region is produced by a hierarchical subdivision of the image into ever smaller image regions.

33. The method as claimed in claim 32, wherein the at least one filter parameter and/or the at least one parameter of the function is contained in a coded image sequence and/or can be deduced from at least one predefined coding parameter.

34. The method as claimed in claim 33, wherein said filtering uses at least in part the partitions defined as part of the movement estimation and which represent image regions moved via relevant movement vectors.

35. A method for decoding a series of digitized images which have been coded to produce a coded signal which depends on image content of images, comprising:
reconstructing an uncoded signal;
deriving reconstructed images from the uncoded signal;
filtering the reconstructed images in accordance with filtering used to produce the coded signal and during which each reconstructed image is divided into partitions; and
defining at least one filter parameter for each partition with at least some of the partitions each described by at least one parameter of a function specifying a path of pixels within a predefined image region, the path of pixels dividing the predefined image region into at least two partitions.

36. A method for coding and decoding a series of digitized images, comprising
coding the digitized images in the series using the method as claimed in claim 1; and
decoding the coded images using the method as claimed in claim 35.

37. A coding device for coding a series of digitized images having a plurality of pixels, comprising
a coding facility coding a signal which, for each of the images concerned, depends on their image content, where the coding facility includes:
a reconstruction facility reconstructing an uncoded signal and deriving reconstructed images from the uncoded signal;
a filtering facility filtering the reconstructed images by dividing each reconstructed image into partitions, where for each partition at least one filter parameter is defined, with at least some of the partitions each described by at least one parameter of a function specifying a path of pixels within a predefined image region, the path of pixels dividing the predefined image region into at least two partitions.

38. The device as claimed in claim 37, wherein a prediction error, between an image currently to be coded and at least one reconstructed and predicted image, is produced as the coded signal, with the prediction error being determined, by a prediction loop, from at least one earlier reconstructed image subject to movement compensation, making use of movement vectors determined through movement estimation, the reconstructed image being used, after the movement compensation within the prediction loop, in reconstructing at least one subsequent image.

39. A decoding device for decoding a series of digitized images, comprising:
a decoding facility processing a coded signal which depends on image content of images, including
a reconstruction facility reconstructing an uncoded signal and deriving reconstructed images from the uncoded signal;
a filtering facility filtering the reconstructed images in accordance with filtering used to produce the coded signal and during which each reconstructed image is divided into partitions where for each partition at least one filter parameter is defined, with at least some of the partitions each described by at least one parameter of a function specifying a path of pixels within a predefined image region, the path of pixels dividing the predefined image region into at least two partitions.

40. A codec for coding and decoding a series of digitized images, comprising the coding device as claimed in claim 37 and the decoding device as claimed in claim 39.
